(19) United States
(12) Patent Application Publication
(10) Pub. No.: US 2007/0085053 A1
(43) Pub. Date: Apr. 19, 2007

(54) Process for preparing superparamagnetic transition metal nanoparticles

(76) Inventors: John S. Gergely, Avondale, PA (US); Edwin S. Marston, Wilmington, DE (US); Shekhar Subramoney, Hockessin, DE (US); Lu Zhang, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/250,336

(22) Filed: Oct. 14, 2005

(51) Int. Cl. C01G 49/08

(52) U.S. Cl. 252/62.56; 977/900

(57) ABSTRACT

A process for preparing superparamagnetic transition metal nanoparticles by introducing into a gas stream a hydrocarbon and a transition metal carboxyl wherein the transition metal carbonyl is introduced downstream from the hydrocarbon; wherein at the point of introduction of the hydrocarbon the gas stream is in the form of a plasma, and wherein at the point of introduction of the transition metal carbonyl the gas stream is at a temperature of at least 1000° C.; followed by quenching to form carbon-coated transition metal nanoparticles; and wherein the gas stream consists essentially of at least one inert gas and hydrogen.

### FIELD OF THE INVENTION

The present invention is directed to a method for preparing oxidatively passivated superparamagnetic transition metal nanoparticles utilizing a gas stream comprising at least one inert gas and hydrogen.

### BACKGROUND OF THE INVENTION

It is known in the art that iron particles in the size range of about 5 nm exhibit superparamagnetic properties. That is, there is no residual magnetism so that no hysteresis is observed in a magnetization/demagnetization cycle. Superparamagnetic particles are useful in that they form stable fine particle dispersions by virtue of having no permanent magnetism but become highly magnetized when they are subject to an external field allowing them to be recognized or separated by their magnetic signature.

One long-recognized problem with very fine metallic particles, particularly iron, is that they are pyrophoric. Thus, it is necessary to chemically passivate the iron nanoparticles if they are to be useful. It has been found in the art that carbon-coated iron nanoparticles can be prepared by various methods.

Scott et al., Mat. Res. Soc. Symp. Proc. Vol 457 (1997), 219-224, discloses carbon coated iron cobalt nanoparticles synthesized in a radio-frequency plasma torch. In the process, a combination of iron and cobalt powders are combined in an argon plasma gas with acetylene. A mixture of argon and hydrogen are employed in the so-called sheath gas. The product thereof comprises highly agglomerated about 20 nm iron-cobalt particles embedded in a carbon matrix.

Gedanken et al., U.S. Patent Publication 20030017336 discloses preparation of hydrocarbon polymer coated superparamagnetic iron nanoparticles prepared by sonicating Fe(CO)₅ in a polymerizable hydrocarbon solvent.

Dravid et al., U.S. Pat. No. 5,472,749 discloses preparation of graphite encapsulated nanophase particles using a tungsten arc to heat graphite in the presence of an iron or other anode.

Ruoff et al., U.S. Pat. No. 5,547,748 discloses preparation of metallic particles about 25-30 nm in size encapsulated in polyhedral graphitic shells in a carbon arc discharge process wherein one carbon electrode contains a core of a metal.

Dumitrache et al., Diamond and Related Materials, 13 (2004), 362-370, discloses preparation of graphite-coated iron nanoparticles with average size less than 10 nm and a narrow size distribution. The nanoparticles are prepared by feeding a combination of Fe(CO)₅, ethylene, and acetylene through a continuous CO₂ laser beam.

In view of the foregoing it is believed advantageous to provide a novel process for making carbon-coated iron nanoparticles.

### SUMMARY OF THE INVENTION

The present invention provides a process comprising introducing into a gas stream a hydrocarbon and a transition metal carbonyl wherein the transition metal carbonyl is introduced downstream from the hydrocarbon; wherein at the point of introduction of the hydrocarbon the gas stream is in the form of a plasma, and wherein at the point of introduction of the transition metal carbonyl the gas stream is at a temperature of at least 1000° C.; followed by quenching to form carbon-coated transition metal nanoparticles; and wherein the gas stream consists essentially of at least one inert gas and hydrogen.

### BRIEF DESCRIPTION OF THE DRAWINGS

FIG. 1 is a schematic representation of a gas entrainment and conditioning apparatus.

FIG. 2 is a schematic representation of a DC plasma torch reactor.

FIG. 3 is a Transmission Electron Micrograph (TEM) of the particles produced in Example 1.

FIG. 4 is a TEM of the particles produced in Example 2.

FIG. 5 is a TEM of the particles produced in Example 4.

FIG. 6 is a TEM of carbon pulp and particles produced in Comparative Example 8.

FIG. 7 is a TEM of particles produced in Example 9.

FIG. 8 is a TEM of particles produced in Example 10.

FIG. 9 is a schematic representation of a multiport reactor.

### DETAILED DESCRIPTION

The present invention is directed to a process comprising combining a transition metal carbonyl with a hydrocarbon in a gas stream being flowing plasma or plasma-heated plasma gas, the gas comprises at least one inert gas and hydrogen followed by a quenching step to form carbon-coated transition metal nano-particles. Accordingly, a transition metal carbonyl and a hydrocarbon are fed into a flowing plasma or plasma-heated plasma gas, the plasma gas comprising an inert gas and hydrogen. The product produced comprises transition metal nanoparticles coated with turbostratic carbon. Turbostratic is a term of art referring to two-dimensionally ordered carbon. The transition metal nanoparticles so formed are oxidatively passivated by virtue of the carbon coating.

By the term “inert gas” is meant one or more gases selected from the group helium, neon, argon and xenon.

It shall be understood that all materials employed in the practice of the present invention are of high purity in order to avoid contamination in the highly reactive environment produced according to the process hereof.

In a first step of the process, plasma is formed using conventional methods in which an ionizable gas is subject to a sufficiently high voltage that ionization occurs. Any method known in the art for forming plasma is suitable for use. For example, methods may include direct current (DC) plasma torches, radio-frequency (RF) plasma torches, carbon arcs, lasers, electron beams, and the like. Carbon arcs are less preferred because of potential interference from unwanted carbon contributed by the carbon electrode.

In the process, a gas stream is used. The stream is described as follows. A plasma gas is caused to flow into a high voltage region where it undergoes ionization to form plasma. The prepared plasma is then caused to flow into a reactor chamber where a hydrocarbon and a transition metal carbonyl are introduced. The transition metal carbonyl is introduced downstream from the entry point of the hydrocarbon. In one embodiment prior to introduction the transition metal carbonyl may be cooled below room temperature. At the point of introduction of the transition metal carbonyl into the gas stream, the gas stream is at a temperature of at least 1000° C., preferably at least 2000° C. In some embodiments at least a portion of the hydrocarbon is introduced into the plasma. In some embodiments the downstream introduction of the transition metal carbonyl may be into a plasma-heated plasma gas which is reconstituted into the non-ionic form upon sufficient cooling of the plasma, so that the combination of the transition metal carbonyl and the hydrocarbon is in fact effected in the plasma-heated plasma gas rather than in the plasma itself. The plasma-heated plasma gas though not plasma is still quite hot, estimated to be about at least 1000° C. The term “plasma gas” as employed herein refers to the gas which is subject to high voltage which induces ionization thereof, thereby forming plasma—an ionized gas. That is, the plasma gas is not ionic in nature, while the plasma is ionic in nature. The flow of the plasma gas may be intermittent, but is preferably continuous.

In one embodiment a portion of the hydrocarbon is introduced into the plasma upstream from the introduction point of the transition metal carbonyl, while another portion of the hydrocarbon is employed as the carrier and make-up gases for the transition metal carbonyl input stream.

The plasma gas comprises a mixture of at least one inert gas and hydrogen, preferably argon and hydrogen. It was found that excessive amounts of hydrogen may interfere with the formation of the plasma. It is also found that the omission of hydrogen in the plasma gas results in the formation of layered sheet-like carbon structures intermixed with the desired carbon-coated transition metal nanoparticles. Hydrogen greatly reduces or eliminates the occurrence of the layered carbon by product. While a suitable range in flow rates will depend upon the scale of the apparatus, it has been found using the apparatus described herein that argon/hydrogen flow rates of about 14/1 l/min was satisfactory.

After the plasma is formed, the plasma is caused to flow into a reaction chamber wherein a hydrocarbon gas or liquid and a transition metal carbonyl vapor are introduced. Any readily vaporized hydrocarbon may be employed but alkanes having 1 to 5 carbons are preferred. Most preferred is methane. Any transition metal carbonyl is suitable. This includes but is not limited to Fe(CO)₅, Ni(CO)₄, and Co(CO)₈. Preferred is Fe(CO)₅. Flow rates of the gas stream will depend upon the scale of the apparatus. In an embodiment employed herein, methane flow rates in the range of 0.1 to 0.5 l/min have been found to be satisfactory with flow rates of Fe(CO)₅ in the range of 0.01 to 0.15 g/min. The equipment used to prepare superparamagnetic carbon-coated iron nanoparticles comprises an iron pentacarbonyl vapor phase source, and a plasma torch reactor.

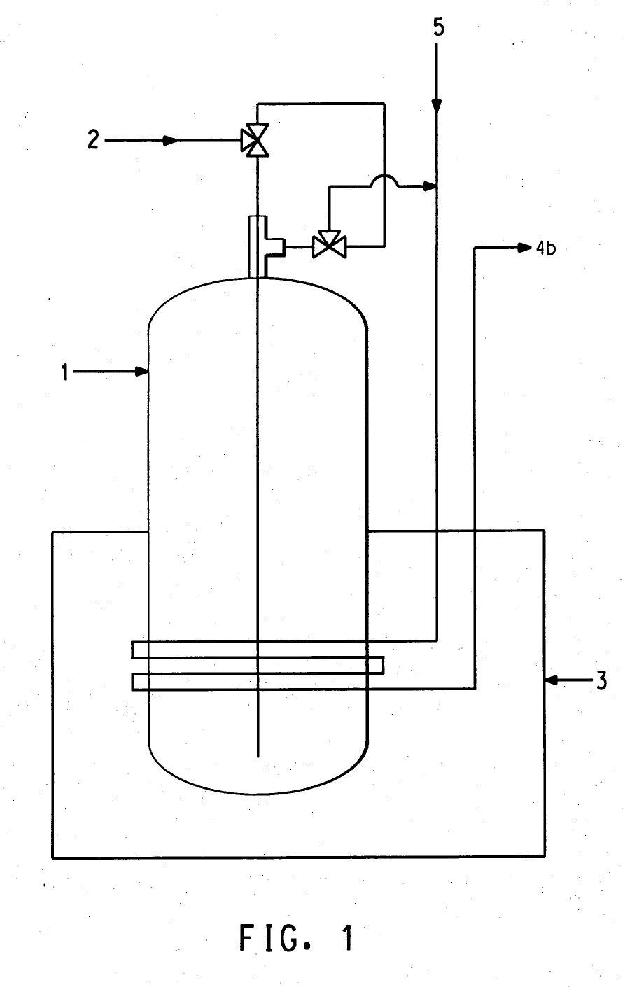

The means for introducing the hydrocarbon and transition metal carbonyl into the plasma is not critical. Any method known in the art for adding a known amount of vapor of a volatilizable liquid at a constant rate may be employed, as may any known method for flow monitoring and controlling of a hydrocarbon vapor. One embodiment found to be useful is to combine the transition metal carbonyl vapor with the hydrocarbon by employing a vapor entrainment device, shown in FIG. 1, wherein the hydrocarbon vapor is bubbled through the transition metal carbonyl in liquid form. If the transition metal carbonyl is held at a constant temperature as in a bath, the concentration of transition metal carbonyl entrained by the hydrocarbon vapor will be controlled, and will depend entirely upon the flow rate of the hydrocarbon. When the transition metal carbonyl is a solid at room temperature, as is the case for Co(CO)₈ it is necessary to heat the transition metal carbonyl to above its melting temperature in order to effect the bubbling method for metering the flow of transition metal carbonyl into the plasma.

Accordingly, the hydrocarbon is introduced into the plasma, preferably at the hottest point where the plasma exits the plasma torch. While it is not necessary to combine the transition metal carbonyl with additional hydrocarbon, employed as carrier or make-up gas, prior to introduction into the plasma, it is preferred. It is found that there is a minimum volume flow rate of the carrier plus make-up gas in order for the process to operate effectively to produce useful quantities of the nanoparticles. In the process, a volume flow rate of carrier plus make-up gas of at least 0.1 l/min is required. It is further found that excessive carrier gas flow rates can result in excessively high concentrations of the transition metal carbonyl which results in rapid plugging of the injector tip.

While the particular method employed for introducing the reactants into the plasma is not important, the order of introduction is. It was found that obtaining the smallest particle size and narrowest polydispersity dictates the order of introduction of the reactants and the interval between their respective introductions. The hydrocarbon is introduced first, that is, upstream from the point of introduction of the transition metal carbonyl. Preferably, the hydrocarbon is introduced at the hottest point, where the plasma emerges from the plasma torch. The transition metal carbonyl is introduced downstream therefrom. It is not known whether at the entry point of the transition metal carbonyl the plasma still exists or not. However, it is believed that by that point, the plasma has reverted to the non-ionized plasma gas, although it is still very hot, estimated to be at least 1000° C.

FIG. 1 shows a design for a vapor entrainment apparatus suitable for use in the present invention as a feeding device for the transition metal carbonyl. The vapor entrainment apparatus consists of a sealed cylinder, 1, a carrier gas stream inlet, 2, a constant temperature bath, 3, and an exit port 4a connecting to a second gas stream called the “make up” gas which is fed in at 5, combined with the carrier gas stream. The hydrocarbon gas feed inlet 5 serves to direct the hydrocarbon gas through the constant temperature bath as well, and then to the injection port, 4b, of the plasma torch reactor. As depicted in FIG. 1, the carrier gas containing the transition metal carbonyl is combined into the make-up gas stream and then cycled through the constant temperature bath. In one embodiment, at least one of the carrier gas and the make up gas are a hydrocarbon gas, such as methane.

The purpose of the make-up gas stream is to provide sufficient volume flow of the Fe(CO)₅-containing feed to permit good mixing to be obtained with the heated plasma or plasma gas. It is found that if insufficient volume flow is provided, sufficient mixing with the heated plasma or plasma gas is not obtained. It is possible in the practice of the invention to eliminate the make up gas stream and simply increase the feed rate of the carrier gas, but this may cause excess Fe(CO)₅ to be entrained which results in clogging of the injector port.

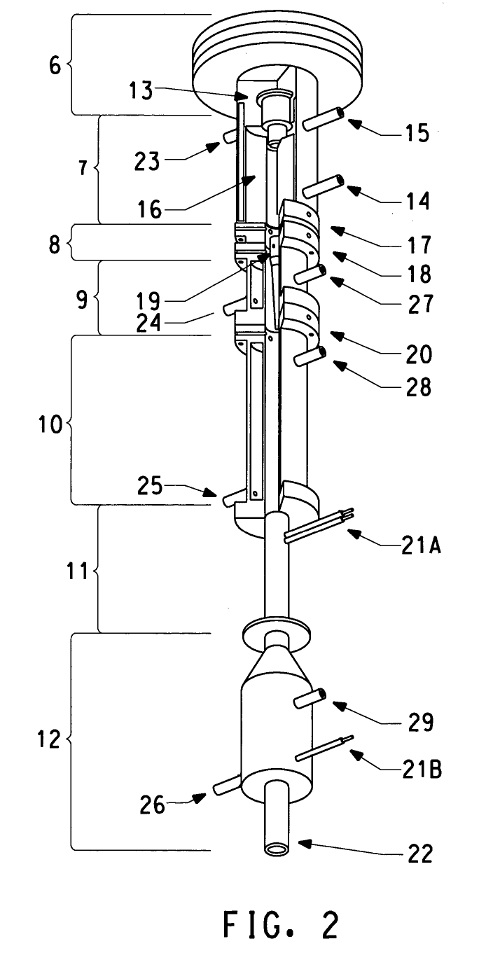

A plasma torch reactor suitable for use in an embodiment, illustrated in FIG. 2, consists of seven sections, labeled 6 to 12. An electromagnet 6 surrounds a plasma gun 7 having a cathode 13 and annular anode 16 that generate plasma upon being energized. The electromagnet 6 produces an axial magnetic field in the direction of gas flow causing rotation of the electric arc between the cathode and anode which provides improved uniformity in the production of the plasma from the plasma source gas and more homogeneous wear on the anode surface. Cooling water is admitted through port 14 and discharged through port 23. High purity inert gas and hydrogen gas are mixed and fed through feed port 15. A plasma gun is attached through a spacer 8 to a reactor/nozzle assembly 9. Spacer feed port 17 admits a methane feed. The water cooled nozzle holder 18 supports a ceramic nozzle 19. Nozzle holder feed ports found in nozzle holder 18 admit the transition metal carbonyl feed stream from the vapor entrainment apparatus (shown in FIG. 1). The nozzle 19 discharges into a quench chamber 10. Helium is introduced through three ports one of which is marked port 20 to aid the quench. The quench chamber is attached through an adapter 11 to a water-cooled product collector 12 containing a fine sintered INCONEL® filter (not shown). Provision for connections to pressure transmitters and temperature probes are at 21A and 21B. Filtered waste gases exit to a scrubber at 22. Various cooling water ports are numbered 24-29.

The nozzle assembly of FIG. 2 allows maintenance of one-dimensional flow in the axial direction with minimum back-mixing. Prevention of back mixing is thought to enhance product uniformity by preventing the build up of larger than desired particulate matter. The nozzle also provided a fast quench by providing cooling prior to gas entry into the rare-gas flushed quench chamber.

While the nozzle assembly, 9, provides a convenient arrangement for effecting the reaction followed by rapid quenching, it may be replaced by a simple reaction chamber, possibly with multiple ports arranged longitudinally along the flow path in order to permit variability in the position of introduction of the transition metal carbonyl.

### EXAMPLES

In the following examples, the apparatus employed comprised a vapor entrainment device as illustrated in FIG. 1 and a plasma torch as illustrated in FIG. 2. In the vapor entrainment device, or bubbler, the controlled temperature bath was an iced salt brine at −10° C. The transition metal carbonyl was Fe(CO)₅. The cylinder, shown as 1 in FIG. 1, was a 150 cc cylinder, cleaned and evacuated, and then at least partially filled with iron pentacarbonyl. Methane, employed as a carrier gas, was fed through the liquid Fe(CO)₅ in the cylinder at the rate indicated in the examples. Downstream from the cylinder, the carrier gas was combined with an additional methane stream called a “make up” gas, and the mixture was fed through the brine bath to ensure uniform controlled temperature of injection into the plasma gas at the point indicated in the examples.

The DC plasma torch reactor was equipped with a modified Metco type MBN plasma gun (available from Sulzer Metco Inc., Westbury N.Y.), having a maximum power of 40 kW (500 A at 80 V). The plasma torch current was set at 110 A unless otherwise noted. The plasma torch was provided with a water-cooled copper anode, Metco MB63, and a thoriated tungsten tip water-cooled copper cathode, Metco MBN430. The plasma torch was modified by placing an in-house fabricated electromagnet around the torch to produce an axial magnetic field in the direction of plasma gas flow. This ensured rotation of the electric arc between the cathode and anode, especially at low gas flow rates. The arc needed to be constantly rotated to prevent anchoring and to provide even wear to the anode. The electromagnetic was water-cooled, machine wound and housed in a plexiglass enclosure. The magnet was operated at 90% full scale voltage, which was ˜35 volts. Argon (ultra high purity, MG Industries Malvern, Pa.) and hydrogen (ultra high purity, also from MG Industries) gases were fed through the torch at 14 and 1.05 l/min., respectively.

With reference to FIG. 2, in those experiments in which the nozzle assembly shown therein was employed, the plasma torch reactor was configured as follows: Below the plasma torch was placed a 1.5-inch (3.8 cm) spacer with three ⅛-inch (3.175 mm) radial feed ports, two capped, and one used to feed methane (ultra high purity, MG Industries) at 0.3 L/min. Below the spacer was placed a 3-inch (7.6 cm) water-cooled nozzle holder containing a 3-inch (7.6 cm) ceramic nozzle (made by Insaco, Inc., Quakertown Pa.) and three radial input ports with feed injectors, two capped and the other to feed iron pentacarbonyl (Sigma-Aldrich, St. Louis Mo.) contained in the methane carrier gas.

The main methane feed stream was introduced into the reactor below the exit of the torch and above the nozzle. The Fe(CO)₅ containing feed stream was introduced into the reaction zone of the nozzle assembly. Since the Fe(CO)₅ was fed into the reactor through feed ports that extended radially into the nozzle, the nano-size iron particles were formed and coated inside the nozzle. Below the nozzle holder was a water-cooled quench chamber that had three radial input ports to provide additional quench using He (scientific grade, MG Industries, see above) fed at 5 l/min through each of the ports for a total He quench of 15 l/min. Below the quench chamber was an adapter connecting the quench chamber to the water-cooled, single-filter element product collector. The collector housed a 3 micrometer sintered INCONEL® 600 filter element. The carbon-coated nanometer iron particles were collected on the filter and removed for analysis.

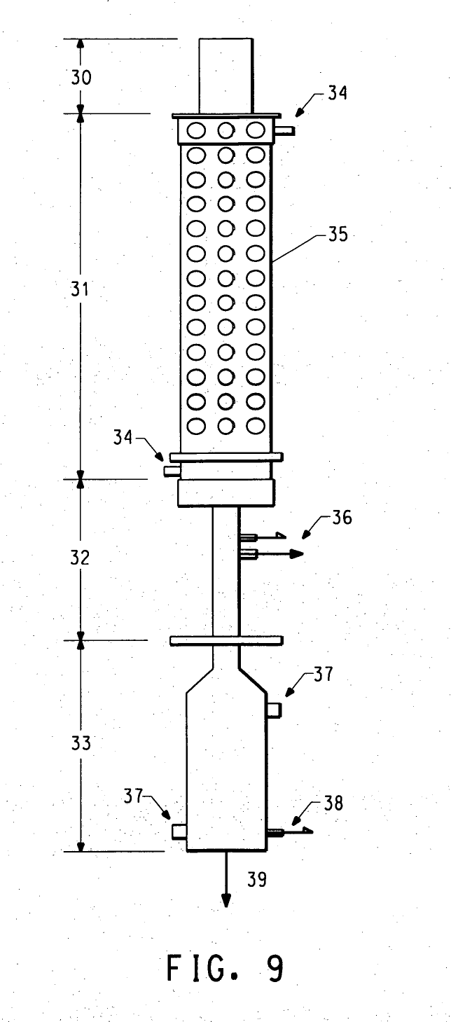

In the examples wherein the nozzle is not employed, it is replaced by a multiport reaction chamber (as illustrated in FIG. 9) provided with a series of input ports arranged linearly in the direction of flow to permit introduction of the Fe(CO)₅ at variable distances from the input of the main methane feed.

It was found in performing the examples described that both the nozzle and the methane injection ports were subject to plugging. For runs of greater duration than about 30 minutes, it was usually necessary to stop to clear a plug. The situation was aggravated when the combination of carrier gas and make-up gas flow rates was below about 0.7 l/min.

### Example 1

A brine ice bath was employed to keep the Fe(CO)₅ and methane carrier gas at −10° C. Carrier gas flow rate was 0.5 l/min., methane make-up gas flow rate was 0.2 l/min., and the main methane feed rate was 0.3 l/min. The Fe(CO)₅/CH₄ mixture was injected into the nozzle at the port shown in FIG. 2. Argon flow rate was 14 l/min and hydrogen flow rate was 1.05 l/min. A total of 10.7 g of carbon-coated nanometer iron particles were produced over 15 hours for a production rate of about 0.7 g/h. The reactor was shut down ten times to clear plugging. Run time between plugs was about 30 minutes and product was collected four times from the filter over the course of the 15 h run. The total amount of iron pentacarbonyl fed was 20 g (feed rate 22 mg/min). The reactor pressure at the start and end of the entire run was 812 and 991 Torr (108 and 132 kPa), respectively.

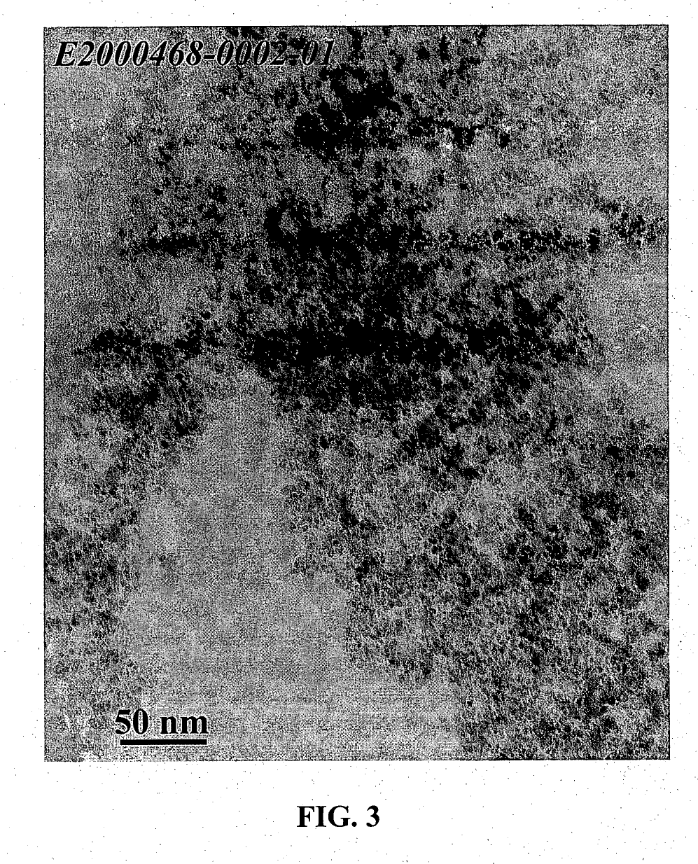

FIG. 3 shows a transmission electron micrograph (TEM) of the product of the reaction collected from the filter.

### Example 2

The configuration of Example 1 was employed except that argon was employed as the carrier gas at 0.3 l/min with no make-up gas.

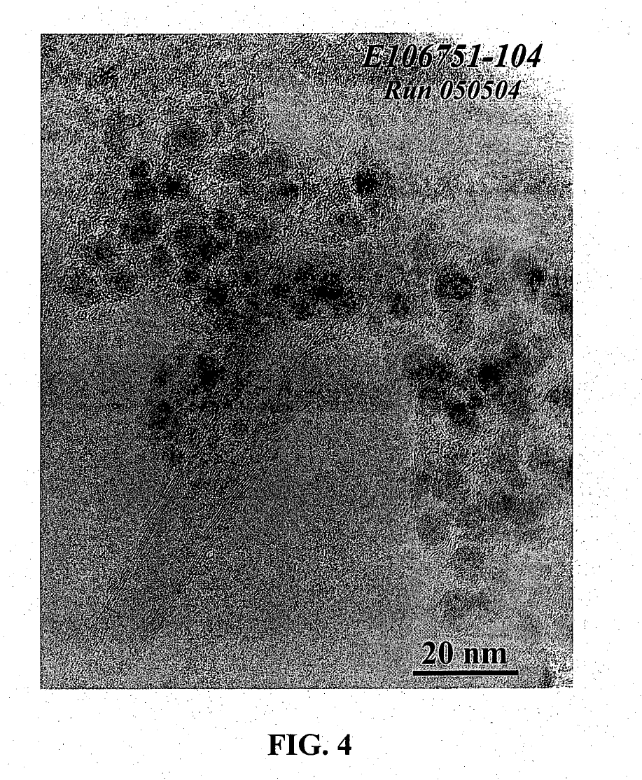

Besides encapsulated particles of Fe, the product was also observed to contain pure C structures such as multi-walled carbon nanotubes. A TEM is shown in FIG. 4, showing both the carbon-encapsulated iron nanoparticles and other carbon structures.

### Example 3

This run was an exact replicate of Example 1. BET surface area was 185 m²/g; particle size distribution by light scattering showed that 90% of the particles were less 169 nm in size.

### Example 4

The configuration of Example 1 was employed except that methane carrier flow rate was 0.5 l/min but there was no additional make-up gas, and no ice bath was used so that the Fe(CO)₅ was at room temperature of about 22° C.

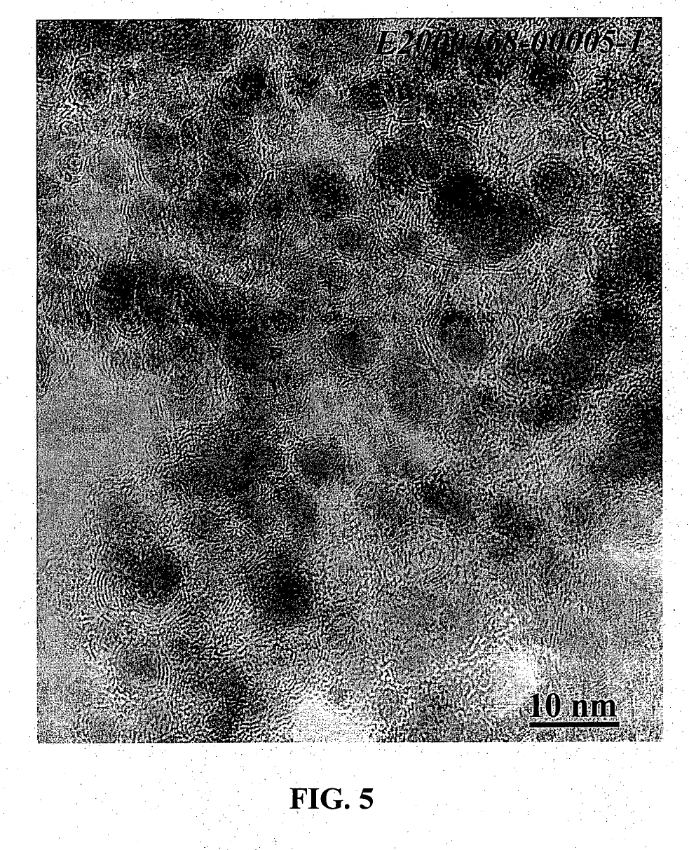

TEM image shown in FIG. 5 shows carbon coated nanoparticles in the size range of about 10 nm. The injector tip that fed the Fe(CO)₅/CH₄ into the reactor was plugged after 24 min.

BET surface analysis showed 122 m²/g. Particle size distribution determined by light scattering showed that 90% of the particles were smaller than 169 nm.

### Comparative Example 5

The configuration of Example 4 was employed except that the make-up gas flow rate was 0.2 l/min. The inlet ports plugged almost immediately. Not enough product to collect. It is not known why this reaction failed.

### Examples 6-7

In the following examples, the nozzle assembly shown in FIG. 2 was replaced by a multiport reactor illustrated in FIG. 9. The reactor was a water-cooled copper cylinder (31) with a cylindrical reaction chamber 1″ in diameter and 15″ long surrounded by a water jacket about 0.5″ thick, which provided 52 inlet ports (35) in 13 rows spaced 1″ apart in a linear array parallel to the direction of flow, thereby allowing material to be introduced at various distances from the plasma torch. The exit temperature of the quench zone was observed to have been 20-30° C. higher than that at the same plasma current when the nozzle was employed.

Other associated equipment shown in FIG. 9 was the same as described in FIG. 2. The bubbler, used as the vapor entrainment device, was the same as is shown in FIG. 1. A legend for FIG. 9 is found below.

The process piping and feed rates were identical to those in Example 1 except where indicated. In all three examples, the main methane stream was fed in at a distance of 0.5″ from the exit of the plasma torch, at a rate of 0.3 l/min. The methane carrier flow rate was 0.1 l/min and the make up gas at 0.2 l/min. The location of the injection point for the Fe(CO)₅ is shown in Table 1 as the downstream distance from the introduction point of the main methane stream.

It was observed that a plasma gun current of 130 amps produces approximately an increase of about 50° C. of the temperature at the entry port of the iron pentacarbonyl stream compared to 110 amps.

TABLE 1

| | | | | Plasma | He |
|---|---|---|---|---|---|
| | | | | Gun | Quench |
| | Run | Fe(CO)₅ | H₂ rate | Current | gas flow |
| | # | port | (l/min) | (amps) | rate (l/min) |
| Comp. Ex. 8 | −02 | 2″ | 0 | 130 | 15-30 |
| Example 6 | −05 | 1″ | 1 | 110 | 15 |
| Example 7 | −06 | 2″ | 1 | 110 | 15 |

### Comparative Example 8

Using the apparatus and process from Examples 6 and 7, a reaction was run for 60 minutes at 130 amps plasma current. No hydrogen was added to the argon plasma gas. The iron pentacarbonyl was fed in at a port spaced 2 inches (5.1 cm) downstream from the main methane feed port. The pressure in the reaction vessel was observed to increase by 57 torr during the reaction. The total product collected was 1.2 g, 0.6 g as an even deposit along the filter element; 0.6 g deposited on the wall of the reaction chamber near the feed ports.

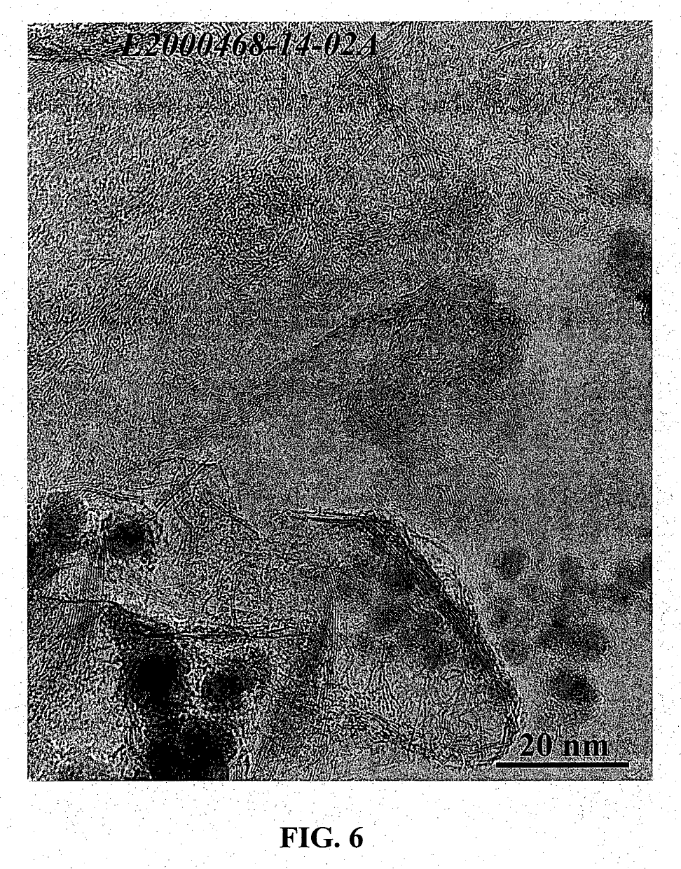

FIG. 6 shows a TEM of the material collected from the filter. There is extensive carbonaceous material in sheet form with some indication of encapsulated iron particles.

### Example 9

The reaction was run for 18 minutes with a pressure increase of 19 torr was observed. The plasma current was 110 amps. The iron pentacarbonyl injection point was located 1″ downstream from the main methane stream input point. 1 l/min of hydrogen was added to the argon flow of 14 l/min. Total product collected was 1.1 g, 0.5 g from the filter, and 0.6 g from the reactor wall near the feed ports.

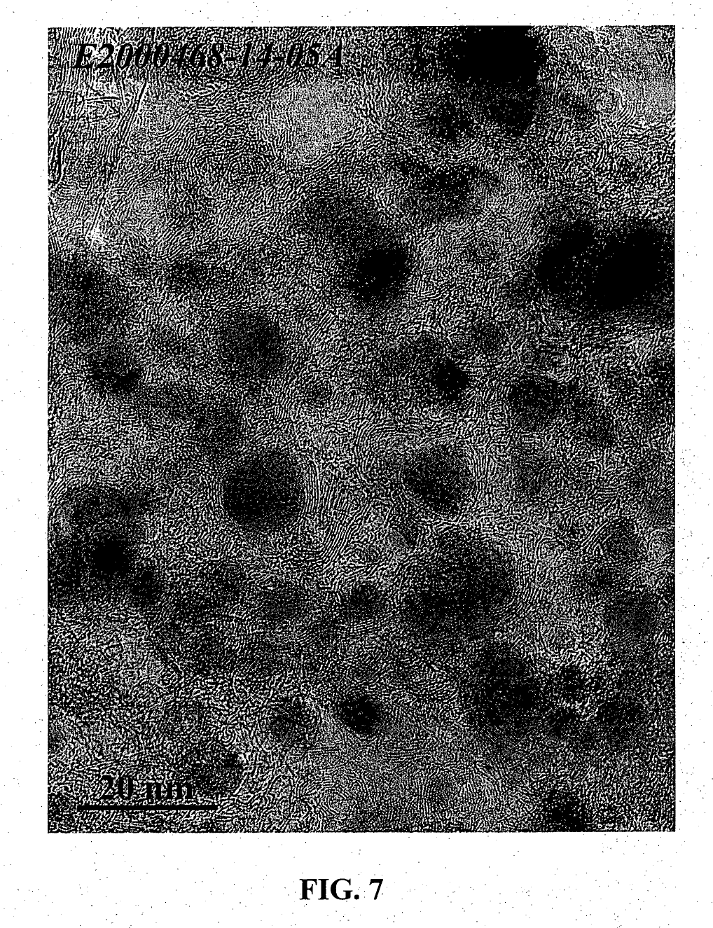

FIG. 7 shows the TEM obtained for the material taken from the filter.

### Example 10

The reaction was run in the same manner as in Example 6, except that the injection point for the iron pentacarbonyl was located 2″ downstream from the main methane stream input. The reaction was run for 32 minutes, with an observed pressure increase of 16 torr. The total product collected was—0.3 g, 0.2 g from the filter and 0.1 g from the reactor wall near the feed ports.

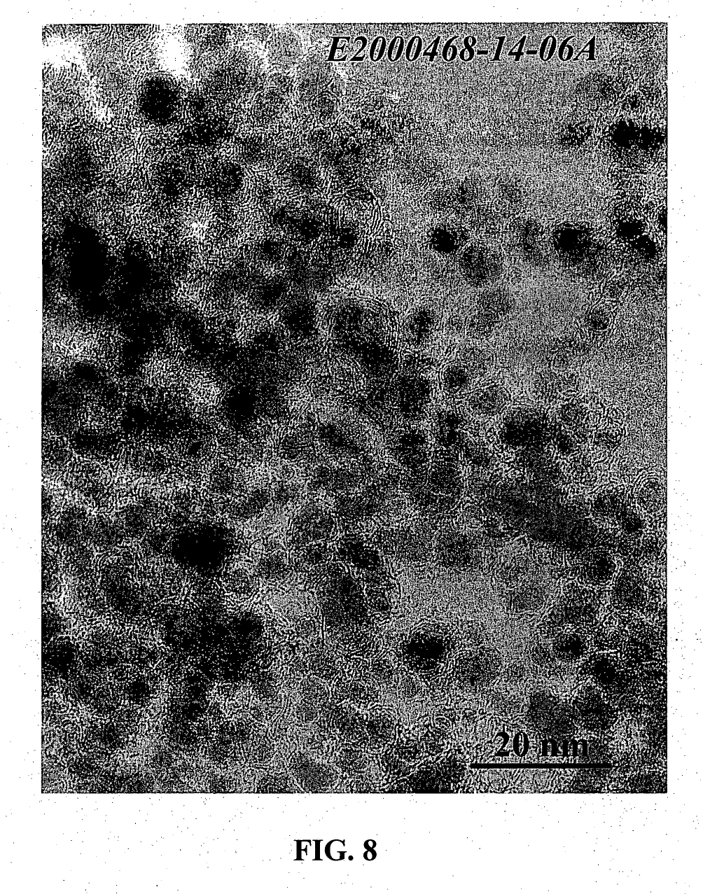

FIG. 8 shows a TEM of the product collected from the filter. A high preponderance of iron particles of about 5 nm size was observed.

Legend for FIG. 9

30—Plasma Gun

31—Multi-port Reactor

32—Adapter

33—Product Collector

34—Cooling Ports

35—Fifty-two Feed Ports

36—Instrumentation Connections

37—Cooling Ports

38—Instrumentation Connection

39—Exit to Scrubber

We claim:

1. A process comprising introducing into a gas stream a hydrocarbon and a transition metal carbonyl wherein the transition metal carbonyl is introduced downstream from the hydrocarbon; wherein at the point of introduction of the hydrocarbon the gas stream is in the form of a plasma, and wherein at the point of introduction of the transition metal carbonyl the gas stream is at a temperature of at least 1000° C.; followed by quenching to form carbon-coated transition metal nanoparticles; and, wherein the gas stream consists essentially of at least one inert gas and hydrogen.

2. The process of claim 1 wherein the transition metal carbonyl is iron pentacarbonyl.

3. The process of claim 1 wherein the hydrocarbon is an alkane of 1 to 5 carbons.

4. The process of claim 3 wherein the alkane is methane.

5. The process of claim 1 wherein the inert gas is argon.

6. The process of claim 1 further comprising the step of cooling the transition metal carbonyl below room temperature prior to introduction into the gas stream.

7. The process of claim 1 further comprising mixing the transition metal carbonyl with a carrier gas prior to introduction into the gas stream.

8. The process of claim 7 wherein the carrier gas is a hydrocarbon.

9. The process of claim 8 wherein the hydrocarbon is methane.

10. Product made by the process of claim 1.
